(19) United States
(12) Patent Application Publication
(10) Pub. No.: US 2024/0419482 A1
(43) Pub. Date: Dec. 19, 2024

(54) GPU Circuit Self-Context Save During Context Unmap

(71) Applicant: Advanced Micro Devices, Inc., Santa Clara, CA (US)

(72) Inventors: ZengRong Huang, Shanghai (CN); Fang Xia, Shanghai (CN); HaiKun Dong, Beijing (CN); XiaoJing Ma, Shanghai (CN); YongTao Yu, Shanghai (CN); YinZhu Xue, Shanghai (CN); Alexander Fuad Ashkar, Orlando, FL (US); Manu Rastogi, Orlando, FL (US)

(21) Appl. No.: 18/336,420

(22) Filed: Jun. 16, 2023

(51) Int. Cl. G06F 9/48

(52) U.S. Cl. CPC G06F 9/4812

(57) ABSTRACT

Systems and methods for efficient context switching in multithread processors are disclosed. A processing system comprises a direct memory access module configured to detect a preemption request generated by the scheduling circuit. Responsive to the preemption request, the direct memory access module determines whether execution of a first task from a plurality of tasks needs to be replaced by execution of a second task. When the replacement is necessitated, the module saves a first plurality of registers associated with the first task at a memory location transmitted by the scheduling circuit and queues the second task for execution. The memory location is transmitted by the scheduling circuit as part of the preemption request.

### BACKGROUND

### Description of the Related Art

In computer graphics and video processing, a context switch refers to the process of switching between different tasks or threads that are being executed on a graphical processing unit (GPU). This can occur when a GPU is asked to perform multiple tasks at the same time, such as rendering multiple frames of a video game or video playback. When a context switch happens, the GPU must save the current state of the task that it is working on, and then load the state of the new task before it can begin executing it. This process can add additional overhead and latency to the GPU's operation, which can affect performance and responsiveness of the system.

On a GPU, a context is the state of all the GPU resources that can be used during rendering and computation operations, such as memory objects, shaders, pipeline states and other. Swapping contexts can be costly, as the GPU needs to reload the context's state and to wait for the completion of previous operations, but it is necessary to perform parallel operations, as the GPU can execute only one context at a time.

Traditional GPU context switching procedures can involve significant overhead. For example, performing a context switch may include a handshake with a direct memory access (DMA) circuit, un-mapping existing context data, writing the unmapped context data to memory, and mapping new a context to the DMA circuit. The overhead associated with these procedures results in increased memory traffic and reduces system performance, e.g., when data is moved between registers and memory.

In view of the above, improved systems and methods for GPU context switching are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 is a block diagram illustrating a heterogenous system architecture for context switching.

FIG. 3 is a block diagram illustrating a process control block at least comprising a plurality of registers associated with a process.

FIG. 4 is a generalized flow diagram illustrating a method for context switching between applications.

FIG. 5 is a generalized flow diagram illustrating a method for preemption of queues during a context switching process.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for implementing context switching using system direct memory access (SDMA) circuitry are disclosed. In various implementations, a graphical processing unit (GPU), supporting multiple context-based processing, comprises an SDMA circuit and a scheduling circuit. The scheduling circuit is configured to schedule work items to be processed by one or more shaders associated with the GPU. Each work item (alternatively referred to as a task or application), includes a plurality of context registers, indicative of a current state (or context) of the work item when it is executed or queued for execution. During context switching, the GPU is configured to save the context registers associated with a first work item in a memory, clear all active data queues, and queue execution of a second work item, in response to identifying a preemption request. In an implementation, the preemption request is generated by the scheduling circuit for the SDMA circuit. Further, the memory location, at which the registers of the first work item are to be saved, is specified in the preemption request by the scheduling circuit, thereby enabling the SDMA circuit to save these registers to the memory location, without invoking the scheduling circuit to do so. Consequently, the scheduling circuit can map registers associated with the second work item to the SDMA circuit, without the need of saving registers associated with the first work item. These and other features are described herein.

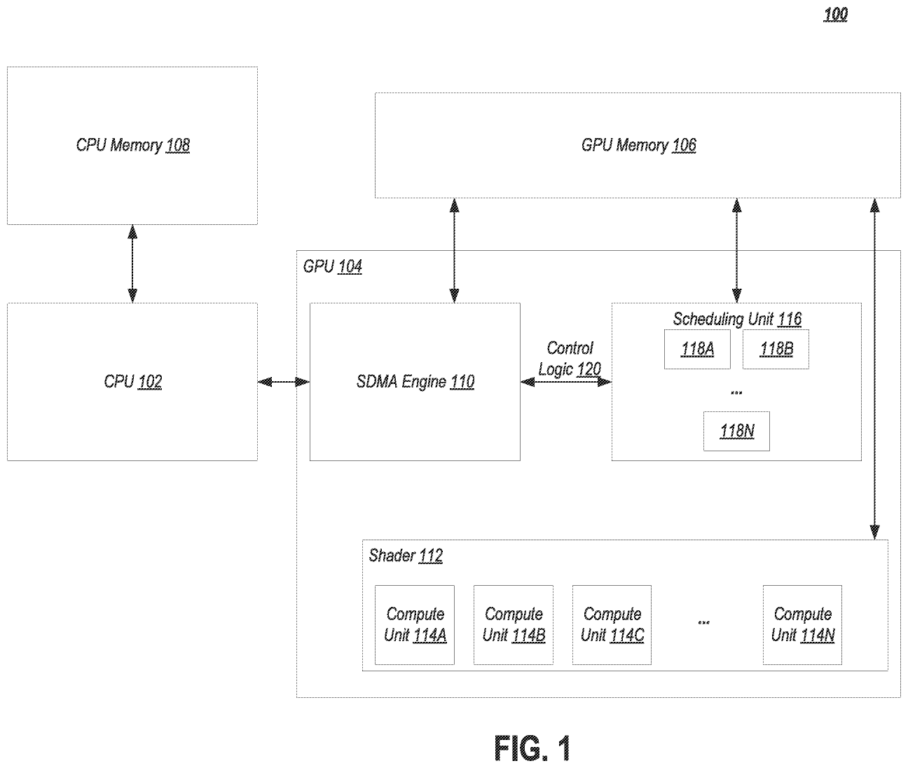

Referring now to FIG. 1, a block diagram of one implementation of a computing system 100 is shown. In one implementation, computing system 100 includes a central processing unit (CPU) 102, a graphic processing unit (GPU) 104, a GPU memory 106, and a CPU memory 108. GPU 104 further includes system direct memory access (SDMA) circuit 110 (or “engine”), and a shader 112. Shader 112 includes a plurality of compute units, depicted as compute units 114A-N, and collectively referred to as compute units 114. In an implementation, the shader 112 includes additional compute units not illustrated in FIG. 1.

In some implementations, the GPU is a vector processor, a general-purpose GPU (GPGPUs), a non-scalar processor, a highly-parallel processor, an artificial intelligence (AI) processor, an inference circuit, a machine learning processor, or other multithreaded processing unit. GPU 104 further includes a scheduling circuit 116. In one implementation, scheduling circuit 116 is hardware or software (a software program or algorithm) executing on GPU 104. Scheduling circuit 116 includes one or more sub-units, depicted as sub-units 118A-N, wherein each sub-unit 118 aids the scheduling circuit 116 in assignment of tasks to various units of the GPU 104, e.g., based on instructions received from the CPU 102. In some implementations, the sub-units 118A-N are configured to use one or more parameters, such as but not limiting to, task dependency graphs, task data mappings, task-dispatch lists, and the like, to assist the scheduling circuit 116 in the scheduling of tasks. For example, using these parameters, a given sub-unit 118 is configured to generate data requirements for a given task in order to schedule the given task. In another example, a sub-unit 118 can be configured to create a set of read and write configurations for a given task using the parameters. In yet another example, a given sub-unit 118 can be configured to use the parameters to create a mapping of tasks to respective objects and/or data. Simply put, the sub-units 118A-N use the above parameters to enable the scheduling circuit 116 to make decisions about scheduling tasks and their sub-data blocks to one or more of the compute units 114A-N. Other implementations are contemplated. As used herein, in various implementations the term “unit” refers to a circuit or circuitry. As such, sub-units may be considered sub-circuits, and so on.

In an implementation, the sub-units 118A-N comprise circuitry configured to perform various tasks including generating scheduling data, based at least in part on the above parameters, so as to enable the scheduling circuit to schedule tasks to one or more compute units 114A-N. Alternatively, each sub-unit 118A-N may be micro-coded and executed within the scheduling circuit 116. For example, each sub-unit 118 may comprise programmable instructions such that these instructions are executed by the scheduling circuit 116 to schedule tasks based on one or more scheduling algorithms. These scheduling algorithms, for example, can include round-robin scheduling, priority-based scheduling, earliest deadline first (EDF) scheduling, machine learning based scheduling, and the like. In several other implementations contemplated, the sub-units 118A-N are configured as a combination of hardware circuitry and programmable instructions. In implementations in which sub-units are software, the software includes instructions executable to perform an algorithm(s) to accomplish the various tasks.

During operation of the computing system 100, CPU 102 issues commands or instructions to GPU 104 to initiate scheduling of a plurality of tasks (applications or work items). A task herein is defined a unit of execution that represents program instructions that are to be executed by GPU 104. For example, a task comprises a thread of work items to be executed by GPU 104. In an implementation, the plurality of tasks are to be executed according to single-instruction-multiple-data (SIMD) protocol, such that each task has associated task data requirements (i.e., data blocks required for execution of each task), as described in the foregoing. Further, each task is executed on a single or multiple compute units of compute units 114A-N.

In an implementation, the GPU 104 can also include control logic 120 (alternatively referred to as “context switch logic 120”) for preempting a task currently executing within shader 112. Context switch logic 120, for example, includes instructions for suspending the currently executed task and save its current state (e.g., shader 112 state, command processor state, etc.) to a specified memory location. In an implementation, in order to switch between tasks, the scheduling circuit 116, using the context switch logic 120, can generate a preemption request, whenever it is determined that a currently executed task is to be paused so that another task can be queued for execution. As used herein, context can be considered as an environment within which kernels execute and a domain in which synchronization and memory management is defined. The context is indicative of data pertaining to a set of devices, the memory accessible to those devices, the corresponding memory properties and one or more command-queues used to schedule execution of a kernel(s) or operations on memory objects. Further, the context also defines the memory and current state of the execution of a task.

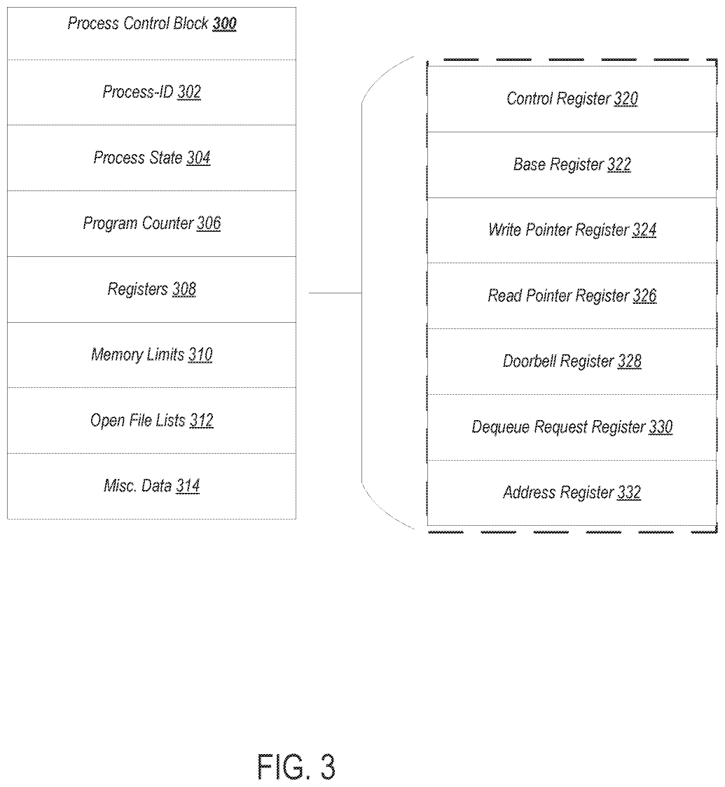

In an implementation, the switching of context, i.e., saving a state of a currently executed task, so as to pause the execution of the task and queue another task, is necessitated when the CPU 102 is interrupted by an on-chip timer or peripheral (not shown). In a multi-processing environment, context switching can happen when the CPU 102 switches from executing one task to another. In a steady state operation, the CPU 102 must save the current task's state, including the contents of general-purpose registers (GPRs), floating point registers (FPRs), and other processor state registers, into memory. Then it loads the next task's state, or “context,” into the registers before beginning execution. The various registers and state information of a given task is detailed in FIG. 3.

Typically, in the GPU 104, the SDMA circuit 110 is a specialized hardware component that is responsible for managing the transfer of data between the GPU 104 and the CPU memory 108. In a context-switching scenario, SDMA circuit 110 can be used to perform context switching by transferring the context of a current task from the GPU 104 to the CPU memory 108, and then transferring a context of a new task from the CPU memory 108 back to the GPU 104.

During context switching, the scheduling circuit 116 generates a preemption request, based on instructions received from the CPU 102. In an implementation, the preemption request is generated when the CPU 102 determines one or more context switch conditions. For example, when a higher priority queue becomes ready, a currently executed task queue is suspended to execute the higher priority queue. In other examples, context switch is initiated in response to a quantum being enabled, e.g., when processing duration for a task queue is exceeded and another queue of the same priority is ready for processing. Yet other examples of initiation of context switch may include a quantum being disabled, a current queue wavefront packet pre-empting the queue from the compute pipeline and schedules, a current queue and compute pipeline becoming empty and any other queue in the same compute pipeline being ready, and/or the operating system requesting the current queue to pre-empt.

In response to the preemption request, the scheduling circuit 116 receives an indication from the SDMA circuit 110, when it is ready to switch between processes. Once the scheduling circuit 116 receives the indication, it stores the current context of the ongoing process in a memory location (e.g., a memory address of the CPU memory 108) and maps data associated with another task onto the SDMA circuit 110. However, this GPU context switching procedure may be inefficient, since the scheduling circuit 116 incurs high working load owing to “handshake” operations with the SDMA circuit 110, such as during un-mapping registers associated with the original task from the SDMA circuit 110 and writing these registers to the memory location. Further, the scheduling circuit 116 may also utilize considerable computing resources in order to map new context onto the SDMA circuit 110 by writing registers associated with the new task to the SDMA circuit 110.

In various implementations described herein, in order to facilitate efficient context switching between tasks, the scheduling circuit 116 generates a memory queue descriptor (MQD) address (e.g., as an address pointer), as part of the preemption request, such that using the MQD address, the SDMA circuit 110 can save the current context of an ongoing task into a specified memory location in the CPU memory 108. This in turn enables the scheduling circuit 116 to have efficient “handshake” operations with the SDMA circuit 110, since the scheduling circuit 116 no longer needs to save the current context of the ongoing task to the memory location. In an implementation, the MQD address at least comprises a memory address pointer pointing to the specified memory location at which the current context of the ongoing task needs to be stored.

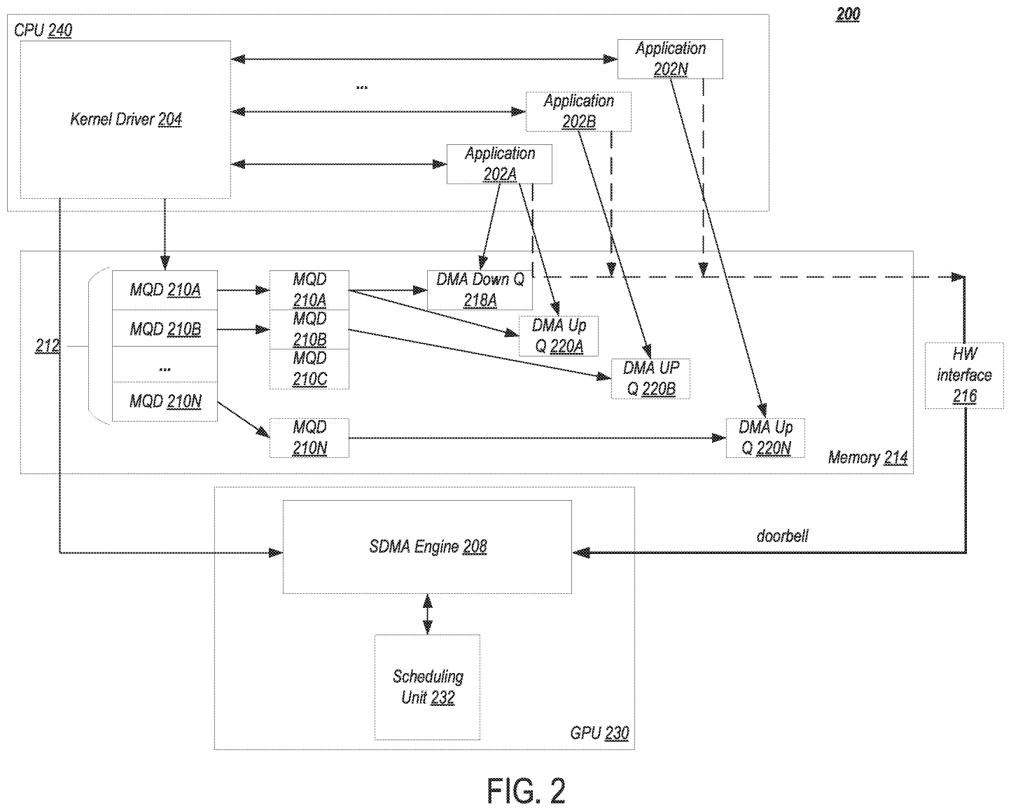

Turning now to FIG. 2, a heterogenous system architecture (HSA) 200 for context switching between tasks is disclosed. As shown in the figure, execution of various applications 202A-N is initiated and controlled to be executed by a CPU 240, by distributing the processing associated with a given application 202 across the CPU 240 and other processing resources, such as a GPU 230.

In one example, the CPU 240 inputs commands for various applications 202 into appropriate process control blocks (not shown), for the GPU 230 to retrieve and execute. An exemplary implementation of a process control block is detailed in FIG. 3. A plurality of process control blocks can be maintained in a system memory 214. Further, as referred to herein, an application 202 is a combination of program parts that will execute on one or more compute units (such as the compute units 114) scheduled for execution on the GPU 230. In various embodiments, an operating system (OS) can execute on the CPU 240 and provide common services that may include scheduling applications 202 for execution within the CPU 240, fault management, interrupt service, as well as processing the input and output of other functions. By way of example, applications 202 include various programs or commands to perform user computations executed on the CPU 240.

In one example, a kernel driver 204 (or “KD 204”) implements an API through which the CPU 240, or applications 202 executing on the CPU 240, can invoke GPU 230 functionality, especially a scheduling circuit 232. Additionally, the KD 204 can perform scheduling of processes to be executed on the GPU 230, e.g., using logic to maintain a prioritized list of processes to be executed on the GPU 230. These processes are then scheduled to be executed by the compute units (not shown) of the GPU 230, by the scheduling circuit 232.

In an implementation, the KD 204 maps command queues, associated with the applications 202, to the scheduling circuit 232 hardware, such that once the mapping is built, applications 202 can directly submit commands to a system memory direct access (SDMA) circuit 208. In an implementation, such mapping is performed by the KD 204. For example, the mapping may be performed by accessing and programming a management input/output (MMIO) register associated with the SDMA circuit 208, via a system management network (not shown).

In the HSA model, the user level application, such as applications 202, cannot access the privileged write and read pointer registers (WPTR/RPTR) associated with the SDMA circuit 208, and therefore a doorbell mechanism is introduced to allow an application to update these registers without direct access to these registers. The doorbell mechanism allows the application to update the registers via the assigned doorbell address space. In an example, the application will first update the copy of the register in a memory, and then write the same data to the GPU 230 doorbell memory management input/output (MMIO) space. In an implementation, the doorbell functionality described herein can act as hardware data path, enabled by a hardware interface 216, between applications 202 and SDMA circuit 208. For instance, in an implementation the doorbell functionality uses Advanced Extensible Interface (AXI) traffic format, such that using the functionality the KD 204 allocates a dedicated doorbell address to the SDMA circuit 208 (e.g., by programming a given SDMA MMIO register). The applications 202 can then use the hardware data path to update a buffer (e.g., a ring buffer or otherwise) write pointer register for the SDMA circuit 208 to notify the SDMA circuit 208 regarding one or more tasks assigned to the SDMA circuit 208. This process is referred to as “ringing a doorbell.” When SDMA circuit 208 detects the doorbell from a given application 202, it compares the doorbell address with a dedicated SDMA doorbell address in the given MMIO register (previously programmed by the KD 204), and accepts data associated with the one or more tasks if the two addresses match.

In an example, the SDMA circuit 208 is a shared resource for the applications 202, including but not limiting to graphics, compute, video, image, and operating system-level applications. Further, the KD 204 in an implementation, serves as a central controller and handles communications between with the applications 202 and the SDMA circuit 208, using a ring buffer. For example, applications 202 submit data from their respective process control blocks to the KD 204, and KD 204 inserts this data to the ring buffer. Information pertaining to each such ring buffer, such as ring buffer base address, ring buffer read and write pointers, and other data is then included in a given memory queue descriptor (MQD) 210.

As described herein, a memory queue descriptor (e.g., MQD 210) is a data structure that describes the properties of a memory queue. A memory queue is a type of memory buffer that may be used to store commands and data that are to be executed on the GPU 230. The MQD 210 contains information such as the starting address and size of the memory queue, the current read and write pointers for the memory queue, and any other metadata that is needed to manage the memory queue. The MQD 210 is used in conjunction with the scheduling circuit 232 to manage the execution of commands on the GPU 230. When a task or command is to be executed on the GPU 230, it is added to the memory queue, and the command scheduling circuit 232 reads the MQD 210 to determine the properties of the memory queue and the position of the next command to execute. In an implementation, MQD 210 can also be used to manage the memory allocation of the memory queues, by keeping track of the current and maximum allocation for the queue and triggers a reallocation if needed.

In an implementation, each application 202 is associated with individual memory queues, such that the KD 204 can generate MQD 210A-N, each describing the individual memory queues for the applications 202. In one implementation, the KD 204 generates MQDs 210A-N associated with applications 202A-N, and combines these MQDs 210A-N into an array 212, which can be referred to as a “run list.” This array 212 or run-list is stored in the system memory 214. According to the implementation, using the run list, the scheduling circuit 232 determines processes to be actively executed for the applications 202, based on instructions received from the CPU 240. Each MQD 210, within the array 212, can contain an active queue. In an example, the active queues are each associated with a compute pipeline and may contain independent processes or a subset of processes associated with the execution of applications 202.

In an implementation, each MQD 210 provides the ability for the operating system to pre-empt an active process from dispatching any more work groups that have not yet allocated any shader resources. Any queue (and its associated processes) that is suspended can be rescheduled for continuation at a later time or terminated if desired by the operating system. Suspending an ongoing process and queueing a new process is herein referred to as “context switching.”

During such a context switching process, an active run-list associated with the original process, e.g., as indicated by the array 212, is replaced by a different run-list associated with the new process, owing to one or more context switching factors. These factors may include execution of a higher priority queue, exceeding processing duration for a queue and another queue of the same priority being ready for processing, a current queue wavefront packet pre-empting the queue from the compute pipeline, etc. In an implementation, each application 202 is associated with a DMA down queue and/or a

DMA up queue, descriptions of which are indicated by respective MQD 210. For instance, during context switching, DMA down queue 218A can be indicative of a memory queue that stores information regarding one or more processes for application 202A that are to be suspended from current execution (i.e., un-mapped from the SDMA circuit 208). Further, one or more new processes to be queued for execution instead are stored in another memory queue(s), e.g., indicated by one or more of DMA up queues 220A-N, such that these are mapped to the SDMA circuit 208 once the un-mapping of the DMA down queue 220A is complete. Based on the mapping and un-mapping of queues, the KD 204 can also update the array 212.

In an implementation, whenever the need for context switching is determined, the scheduling circuit 232 generates a preemption request for the SDMA circuit 208 to handle. In an implementation, the preemption request generated by the scheduling circuit 232 comprises a memory queue descriptor address (MQDA) (e.g., as an address pointer) of the operating system allotted array 212 associated with the original process. In an implementation, the MQDA is indicative of a memory location at which current state of the original process, at least including one or more context registers, is to be stored, such that the original process can be restored for execution at a later time in the processing cycle. In an example, the one or more context registers, along with other information associated with the original process, can be accessed from a process control block associated with the original process. In an example, each context register is indicative of a state of the GPU 230 while execution of the original process. The context registers may include General Purpose Registers (GPRs), Floating Point Registers (FPRs), Condition code register (CCR), and other processor registers.

In one implementation, owing to the MQDA being generated by the scheduling circuit as a part of the preemption request, the SDMA circuit 208 is enabled to save the context of the original process, without invoking the scheduling circuit 232 to do so itself. Once the SDMA circuit 208 has stored the current state of the original process at the memory location indicated by the MQDA, the SDMA circuit 208 can send an acknowledgement to the scheduling circuit 232. In an implementation, this acknowledgement is transmitted in the form of an interrupt. Other implementations are contemplated.

Based on receiving the acknowledgement from the SDMA circuit 208, the scheduling circuit 232 maps a new context (e.g., registers associated with the new process) to the SDMA circuit 208. In an implementation, mapping a new context at least comprises loading data associated with the new process, in the form of MQD array (similar to array 212 described above), for the new process. In an implementation, the context switching process, as described above, enables the scheduling circuit 232 to generate preemption request for multiple queues, simultaneously, that are needed to be dequeued, and wait for them all to be cleared. This optimization reduces the latency required to dequeue queues in an order and may optimize the GPU's performance. Such an optimization may further simplify software running on the scheduling circuit, that is executed for un-mapping the original process's queue from the SDMA circuit 208.

Turning now to FIG. 3, an exemplary process control block 300 is depicted. As described in the foregoing, a process control block comprises data pertaining to one or more applications scheduled to be executed by a processing device. In an implementation, a scheduling circuit (e.g., scheduling circuit 232 of FIG. 2), uses the information present in a given process control block to schedule one or more processes based on instructions received from a central processing unit.

As shown in the figure, the process control block 300, comprises process-ID 302, process state 304, program counter 306, registers 308, memory limit data 310, open file lists 312, and miscellaneous data 314. In an implementation, process-ID 302 comprises a unique identifier that is used to identify a given process. Whenever a new process is created by a user, the operating system allots a number to that process. This number becomes the unique identification of that process and helps in distinguishing that process from all other processes existing in the system. The operating system may set a limit on the maximum number of the processes it can deal with at a time. In one example, if there are n number of the processes queued for execution in the system currently, the process-ID 302 may take on the values between 0 to n−1. The operating system will allocate the value 0 to the first process that arrives in the system, the value 1 to the next process and so on. At this point when the n−1 value is allocated to some process, and a new process arrives, the operating system wraps around and allocates value 0 to the newly arrived process, considering that the process with process-id 0, would have terminated. Process-IDs 302 may be allocated in any numeric or alphanumeric fashion, and such implementations are contemplated.

The process state 304 includes different states of a given process, such as but not limiting to waiting state, running state, ready state, blocked state, halted state, and the like. In an implementation, process state 304 holds the current state of the respective process, e.g., if a process is currently executing the process state may indicate a “running state” for that process. The information in the process state 304 field is kept in a codified fashion.

Program counter 306 is an identifier comprising a pointer to the next instruction that the CPU should execute for a given process. In an example, the program counter 306 field at least comprises an address of the instruction that will be executed next in the process.

Registers 308 store values of the CPU registers for a given process that was last executed. In an implementation, whenever an interrupt occurs and there is a context switch between processes, the temporary information is stored in the registers, such that when the process resumes execution, the processing device can accurately resume the process from its last execution cycle. Further, for the purposes of this disclosure, each of these registers 308, contain data that is associated with a given queue (comprising active processes or processes enqueued for execution). However, other implementations are contemplated.

In an implementation, the registers 308 comprise one or more registers, such as control register 320, base register 322, write pointer register 324, read pointer register 326, doorbell register 328, dequeue request register 330, and an address register 332. Other possible registers are contemplated. In an implementation, the systems described herein may utilize a ring buffer data structure for processing different data when executing one or more tasks. A ring buffer is a data structure that uses a single, fixed-size buffer as if it were connected end-to-end. The buffer operates in a “circular” manner, where the next position to be written to is determined by the current position, and the first position to be read is determined by the oldest stored value. In an implementation, the control register 320 is indicative of information pertaining to the ring buffer data, such as ring buffer enablement, ring buffer size, etc. for a given memory queue (such as memory queues described using MQD 206). Further, base register 322 comprises ring buffer base address of a given queue in the memory. The write pointer register 324 and read pointer register 326, contain a current ring buffer write pointer of the given queue and the current ring buffer read pointer of the given queue, respectively.

The doorbell register(s) 328 includes data pertaining to a doorbell index that identifies a given memory queue. For example, the doorbell register(s) 328, in an implementation, includes memory-mapped I/O (MMIO) base address registers. The doorbell register(s) 328 may further comprise a plurality of doorbells to activate a doorbell notification in response to receiving a doorbell trigger from the driver. As described in the foregoing, the doorbell functionality provides a hardware data path between CPU driver and SDMA circuit. The driver allocates a dedicated doorbell address to the SDMA circuit and uses the hardware data path to update the write pointer register 324 to notify the SDMA circuit 208 about one or more tasks assigned to the SDMA circuit.

In an implementation, the registers 308 comprise one or more context switching control registers, such as dequeue request register 330, and the address register 332. For example, a kernel driver (such as the kernel driver 204 shown in FIG. 2) programs the address register 332 to notify an SDMA about the memory address of memory queue descriptor (MQD) for a given queue. Further, the driver sets the dequeue request register 330 to a predetermined binary value, e.g., 1, in order to notify the SDMA to preempt from the given queue. In response to such programming of registers, the SDMA is enabled to save one or more context registers with the given queue to a memory location of the MQD, and set the dequeue request register 330 to 0 to acknowledge that it is ready for preempting the given queue. Based on said acknowledgement, the scheduling circuit can map a different queue for the SDMA, without needing to save the one or more context registers for the original queue, since these have been already stored by the SDMA.

Memory limits 310 field contains information about memory management systems used by the operating system. This information may include the page tables, segment tables, and the like. Further, open files list 312 includes the list of files opened for a given process. Miscellaneous data 314 can include information about the amount of CPU used, time constraints, jobs, or process number, etc., for execution of a given process.

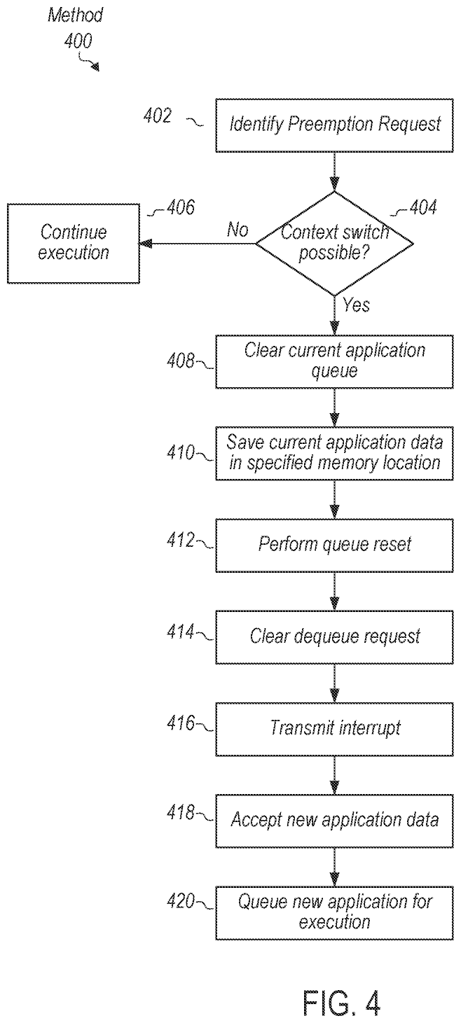

Turning now to FIG. 4, a method 400 for context switching is disclosed. As described in the foregoing, during GPU processing, an SDMA circuit preempts a given queue based on information received from a scheduling circuit. Further, the information received from the scheduling circuit at least in part comprises a MQD address, such that the SDMA circuit is enabled to store one or more context registers associated with an active application queue at a memory location specified by the MQD address, without invoking the scheduling circuit to do so. Although the method 400 is described with respect to context switching performed by an SDMA circuit, in several alternate embodiments, processing units other than the SDMA circuit, e.g., a command processor, can be configured for similar switching contexts (e.g., context switching for graphics tasks) using techniques described herein.

The SDMA can initiate preemption from a given application queue, based on an identified preemption request (block 402). In an implementation, the preemption request is generated by a scheduling circuit when it is determined that an ongoing process (identified by an application queue) is to be suspended such that another process can be queued for execution (i.e., context needs to be switched). In various examples, such a determination is made by the scheduling circuit based on one or more factors such as when a higher priority queue becomes ready, a quantum being enabled, a quantum being disabled, and the like.

The SDMA circuit, responsive to identifying the preemption request, determines whether the context switching is possible (conditional block 404). In some implementations, a scenario may exist in which a context switch is not possible (conditional block 404, “no” leg). In such a case, the SDMA indicates to the GPU to continue execution of the current queue (block 406). However, if context switching is possible, (conditional block 404, “yes” leg), the SDMA clears the current application queue (block 408). For example, for clearing an application queue for an ongoing graphics application, a graphics pipeline can be configured to wait until a given processing unit completes execution of the current instructions.

Once the current application queue(s) are cleared, the SDMA circuit stores the current application data at a specified memory location (block 410). In an implementation, the current application data at least comprises context registers indicative of a current state of the current application. Further, the specified memory location, in an implementation, is indicated by the scheduling circuit in the generated preemption unit. For example, the scheduling circuit can write to a ring buffer preemption register associated with the current application to notify the SDMA circuit about a MQD address for the current application. Based on the MQD address, the SDMA circuit can store the context registers associated with the current application to the memory location indicated by the MQD address.

The SDMA circuit, after storing the context registers associated with the current application, resets the application queue (block 412). In an implementation, in order to reset the application queue, the SDMA circuit clears the application queue of all processes associated with the current application. According to the implementation, the SDMA circuit is configured to wait for a given period of time before resetting the queue, such that one or more essential internal operations are completed before the queue is reset. Further, once the SDMA has finished reset, it clears a queue-reset field for the queue as well as clears all registers associated with the queue to indicate a default value. This may be done as an acknowledgment that queue reset is complete.

Once the preempted queue is reset, the SDMA circuit clears a dequeue request register (block 414). As described earlier, the scheduling circuit driver sets the dequeue request register to a predefined value (e.g., 1) in order to notify the SDMA circuit to preempt from the current queue. Once preemption is complete, the SDMA circuit can clear the dequeue request register by setting it to another predefined value (e.g., 0) that indicates that the preemption is complete. The acknowledgement of the completion of preemption of the current application queue is transmitted by the SDMA circuit to the scheduling circuit in the form of an interrupt (block 416).

In an implementation, the SDMA circuit accepts new application data after the preemption of current application queue is complete (block 418). According to the implementation, the new application data comprises information associated with the last saved state of a new application or process. In an example, the new application data includes context registers, last processor state, timestamp information, and the like associated with the new application. In an implementation, the new application data is mapped onto the SDMA circuit by the scheduling circuit. Once the mapping is complete, the SDMA circuit queues the new application for execution (block 420). The execution is performed till all process in the application queue are complete, the system is idle, and/or another preemption request is identified.

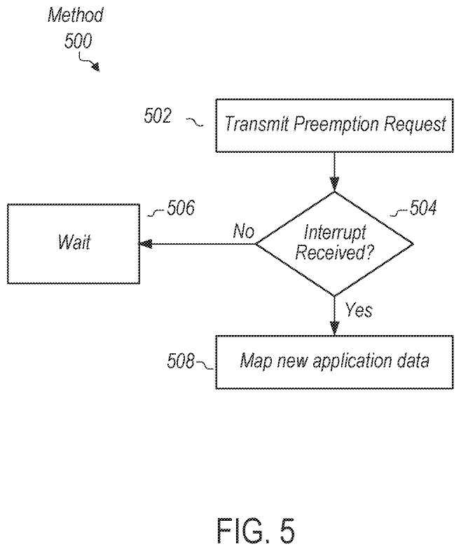

Turning now to FIG. 5, a method 500 for preemption of queues during a context switching process is disclosed. As described in the foregoing, a scheduling circuit generates a preemption request to switch between one process to another process in response to one or more context switching factors. Based on the preemption request, an SDMA circuit stores data associated with a currently executed process and queues a new process for execution.

In an implementation, the scheduling circuit transmits the generated preemption request in response to determining a context switch is necessitated (block 502). According to the implementation, the preemption request at least comprises a memory queue descriptor (MQD) address, such that using the address the SDMA circuit can store the current state of a process being executed (e.g., as indicated by one or more context registers) at a memory location specified by the address, without invoking the scheduling circuit.

After the preemption request is transmitted, the scheduling circuit determines whether an interrupt signal is received from the SDMA circuit (conditional block 504). In an implementation, the interrupt signal from the SDMA circuit is indicative of an acknowledgement that the SDMA circuit has preempted a queue associated with the process that was being executed and stored the current state of the process at the memory location specified by the address. In case the interrupt is not yet received (conditional block 504, “no” leg), the scheduling circuit is configured to wait for the interrupt signal (block 506), e.g., till the interrupt signal is received or a timeout period is elapsed.

However, if the interrupt signal is received (conditional block 504, “yes” leg), the scheduling circuit maps new application data onto the SDMA circuit (block 508). As described above, the new application data includes context registers, last processor state, timestamp information, and the like associated with the new application or process that is to be queued for execution.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a scheduling circuit; and
direct memory access circuitry configured to:
detect a preemption request generated by the scheduling circuit;
responsive to detecting the preemption request, determine whether execution of a first task of a plurality of tasks needs to be replaced by execution of a second task;
save a first plurality of registers associated with the first task at a memory location transmitted by the scheduling circuit, responsive to replacing execution of the first task with execution of the second task; and
queue the second task for execution.

2. The system as claimed in claim 1, wherein the memory location is transmitted by the scheduling circuit as part of the preemption request.

3. The system as claimed in claim 2, wherein the memory location is transmitted by the scheduling circuit as a memory queue descriptor (MQD) address pointer.

4. The system as claimed in claim 1, wherein the first plurality of registers at least comprises a dequeue request register, and wherein responsive to detecting the preemption request, the direct memory access circuitry is further configured to:
clear the dequeue request register; and
transmit an interrupt signal to the scheduling circuit.

5. The system as claimed in claim 4, wherein the scheduling circuit is configured to map a second plurality of registers associated with the second task to the direct memory access circuitry, in response to receiving the interrupt signal.

6. The system as claimed in claim 1, wherein the first plurality of registers comprises one or more of a ring buffer write pointer register, a ring buffer read pointer register, a ring buffer control register, a ring buffer base address, and a doorbell register.

7. The system as claimed in claim 1, wherein the first task is associated with an application, and wherein the system further comprises a kernel driver configured to map one or more command queues, associated with the first task, to the scheduling circuit.

8. A method comprising:
detecting a preemption request generated by a scheduling circuit;
responsive to detecting the preemption request, determining whether execution of a first task from a plurality of tasks needs to be replaced by execution of a second task;
saving a first plurality of registers associated with the first task at a memory location transmitted by the scheduling circuit, responsive to replacing execution of the first task with execution of the second task; and
queuing the second task for execution.

9. The method as claimed in claim 8, wherein the memory location is transmitted by the scheduling circuit as part of the preemption request.

10. The method as claimed in claim 9, wherein the memory location is transmitted by the scheduling circuit as a memory queue descriptor (MQD) address pointer.

11. The method as claimed in claim 8, wherein the first plurality of registers at least comprises a dequeue request register, and wherein responsive to detecting the preemption request, the method further comprising:
clearing the dequeue request register; and
transmitting an interrupt signal to the scheduling circuit.

12. The method as claimed in claim 11, wherein further comprising mapping, by the scheduling circuit, a second plurality of registers associated with the second task to direct memory access circuitry, in response to receiving the interrupt signal.

13. The method as claimed in claim 8, wherein the first plurality of registers comprises one or more of a ring buffer write pointer register, a ring buffer read pointer register, a ring buffer control register, a ring buffer base address, and a doorbell register.

14. A computing system comprising:
a central processing unit;
a graphics processing unit comprising a scheduling circuit and a system direct memory access circuit configured to:
detect a preemption request generated by the scheduling circuit;
responsive to detecting the preemption request, determine whether execution of a first task from a plurality of tasks needs to be replaced by execution of a second task;
save a first plurality of registers associated with the first task at a memory location transmitted by the scheduling circuit, responsive to replacing execution of the first task with execution of the second task; and
queue the second task for execution.

15. The computing system as claimed in claim 14, wherein the memory location is transmitted by the scheduling circuit as part of the preemption request.

16. The computing system as claimed in claim 15, wherein the memory location is transmitted by the scheduling circuit as a memory queue descriptor (MQD) address pointer.

17. The computing system as claimed in claim 14, wherein the first plurality of registers at least comprises a dequeue request register, and wherein responsive to detecting the preemption request, circuitry of the computing system is further configured to:
clear the dequeue request register; and
transmit an interrupt signal to the scheduling circuit.

18. The computing system as claimed in claim 17, wherein the scheduling circuit comprises circuitry configured to map a second plurality of registers associated with the second task to the system direct memory access module, in response to receiving the interrupt signal.

19. The computing system as claimed in claim 14, wherein the first plurality of registers comprises one or more of a ring buffer write pointer register, a ring buffer read pointer register, a ring buffer control register, a ring buffer base address, and a doorbell register.

20. The computing system as claimed in claim 14, wherein the first task is associated with an application, and wherein circuitry of the computing system is further configured to map one or more command queues, associated with the first task, to the scheduling circuit, such that the application is enabled to submit one or more commands to the system direct memory access module.
